(19) United States
(12) Patent Application Publication
(10) Pub. No.: US 2025/0047535 A1
(43) Pub. Date: Feb. 6, 2025

(54) EAVESDROPPING PREVENTION USING CHANNEL-BASED PHASE PRE-EQUALIZATION

(71) Applicant: ISTANBUL MEDIPOL UNIVERSITESI TEKNOLOJI TRANSFER OFISI ANONIM SIRKETI, Beykoz, Istanbul (TR)

(72) Inventors: Muhammad Sohaib Jamal SOLAIJA, Beykoz, Istanbul (TR); Hüseyin ARSLAN, Beykoz, Istanbul (TR); Hanadi Mohammad Yousef SALMAN, Beykoz, Istanbul (TR)

(21) Appl. No.: 18/718,370

(22) PCT Filed: Dec. 7, 2022
(86) PCT No.: PCT/TR2022/051440

§ 371 Date: Jun. 10, 2024

(30) Foreign Application Priority Data
Dec. 9, 2021 (TR) TR 2021/019492

(51) Int. Cl. H04L 27/18; H04L 25/02; H04L 25/03

(52) U.S. Cl. CPC H04L 27/18; H04L 25/0202; H04L 25/03343

(57) ABSTRACT

Disclosed is a method to improve the confidentiality against eavesdropping in wireless communication. The method involves pre-equalizing the channel phase between the legitimate transceivers.

### TECHNICAL FIELD

Present invention relates to a method to improve the confidentiality against eavesdropping in wireless communication. Said method comprises of pre-equalizing the channel phase between the legitimate transceivers.

### PRIOR ART

Wireless systems are prone to various threats including eavesdropping, where a malicious node tries to intercept the ongoing transmissions between legitimate entities. Pre-equalization approach can be considered as one of the physical layer security (PLS) approaches that has shown a good performance with reduced complexity by equalizing the transmitted data by legitimate wireless channel such that an eavesdropper cannot correctly decode the received signals since it has no knowledge about legitimate wireless channel. Therefore, increasing attention is being tunneled towards simple, lightweight, and efficient schemes as the one mentioned in this invention that achieve not only security but also reduce receiver complexity. Different schemes targeting obfuscation of the received data at the eavesdropper have been presented in the literature and summarized below:

Constellation rotation: the modulated symbols are rotated by an angle before transmission and the receiver can decode the received symbols after reversing the angle rotation. The angle of rotation can be:
1) Conventional constellation rotation: fixed angle rotation is applied for all modulated symbols.
2) Pseudo Random constellation rotation: symbol-specific rotation angles have been generated using pseudo random generator.

Constellation shape/type: the constellation shape or type is changed based on a pre-shared sequence between transmitter and receiver.

Constellation mapping obfuscation: the constellation mapping rule is changed at each packet transmission to obfuscate mapping bit stream to modulated symbols.

Addition of artificially interfering signals: the modulated symbols are added to intentionally interfering signals.

The solutions presented in the state of the art are mainly methods or techniques to obfuscate the constellation and they lead to performance degradation due to incorrect detection if the rules/consolation related information are unknown. In addition, they complicate the receiver design since the legitimate receiver requires to apply some process before data detection stage. More specifically, the disadvantages of the aforementioned solutions are presented from security perspective:

Conventional constellation rotation: a weakness in this approach is that a brute force search algorithm for a large number of symbols can correctly identify the rotation angle since it is fixed.

Pseudo Random constellation rotation: In this approach the details of the sequence generator should be shared among the legitimate entities which requires signaling overhead key management and agreement.

Constellation shape/type: In this approach the scheme still depends on a pre-shared data between communicators as in conventional symmetric key encryption. Such a drawback makes it vulnerable to well-known attacks such as adaptive plain-text attacks and brute force search attacks. In addition, changing the modulation type requires changing on the wireless link conditions otherwise it leads to wasting the resources.

Constellation mapping obfuscation: The same problem is raised here, how to securely share the mapping rule between the legitimate entities. In addition, any mistake in the mapping rule, may lead to severe degradation in the legitimate receiver performance especially in high modulation orders.

Addition of artificially interfering signals: This approach degrades the channel capacity and consequently the throughput. In addition, it may cause PAPR increase if the artificial signal is not properly designed.

All in all, when the state of the art is taken into account it is seen that there is need in the art for a lightweight, efficient and resilient method to improve the confidentiality against eavesdropping in wireless communications

### Aims of the Invention and Brief Description

The present invention is related to a method for improving the confidentiality against eavesdropping in wireless communications, wherein said method comprises the steps of
Estimating the wireless channel wherein transmitter starts a channel (gain and phase) estimation process and receiver starts a channel gain estimation process
Obtaining the channel phase vector from the channel estimation process at transmitter
Mapping the transmitted bits to the modulated symbols based on a digital modulation scheme at transmitter
Performing symbol phase pre-equalizing at transmitter characterized in rotating the modulated symbols by an angle that is equal to the negative of instantaneous channel phase
Decoding the received symbols at receiver

This invention is mainly about a phase pre-equalizing technique without any pre-shared sequences. The angles sequence is extracted from the phases of the wireless link between the legitimate entities with the help of channel reciprocity property. The modulated symbols are rotated with respective angle and when it passes through the wireless link between the legitimate entities, only the effect of channel gain remains. Multipoint coordination is used to further obfuscate the received data since the combination of signals with different phases also randomizes the amplitude of the received data

The method of the invention can be used by any wireless communication technology to provide protection against eavesdroppers.

Specifically, standards like 3GPP-based cellular and IEEE 802.11 based Wi-Fi networks are particularly relevant to the invention due to the support of multipoint coordination provided in both standards.

In another embodiment the invention is directed to the use of a method according to present invention in systems and/or devices and/or networks capable of supporting 3GPP-based cellular and IEEE 802.11 based Wi-Fi networks.

Furthermore, the described method in this invention can be implemented on any device, system or network capable of supporting any of the aforementioned standards, code division multiple access (CDMA), frequency division multiple access (FDMA), Global System for Mobile communications (GSM), GSM/General Packet Radio Service (GPRS), Enhanced Data GSM Environment (EDGE), Wideband-CDMA (W-CDMA), Evolution Data Optimized (EV-DO), High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, 5G New Radio (NR), or other known signals that are used to communicate within a wireless, cellular or internet of things (IoT) network.

In a preferred embodiment of the invention, the invention relates to the use of a method according to present invention in systems and/or devices and/or networks capable of supporting 3GPP-based cellular and IEEE 802.11 based Wi-Fi networks, code division multiple access (CDMA), frequency division multiple access (FDMA), Global System for Mobile communications (GSM), GSM/General Packet Radio Service (GPRS), Enhanced Data GSM Environment (EDGE), Wideband-CDMA (W-CDMA), Evolution Data Optimized (EV-DO), High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, 5G New Radio (NR), or other known signals that are used to communicate within a wireless, cellular or internet of things (IoT) network.

The method according to invention improves the confidentiality against eavesdroppers by pre-equalizing the phase of the modulated symbol based on the legitimate channel phase in order to secure the transmitted data.

Motivated by the need for pure-physical-layer approaches, where no pre-sharing or negotiation of fixed secret values/keys are needed, this invention presents a physical-layer security scheme that is lightweight, efficient and resilient against eavesdroppers.

The proposed invention exploits the channel phase in order to guarantee the confidentiality of the transmitted data, and it is based on pre-equalizing every modulated symbol independently.

The symbol phase pre-equalizing is performed based on the probed channel phases. As such, channel phases must be kept secret between the legitimate entities, which can be accomplished by channel reciprocity process where channel response are estimated by both communicating ends without a feedback link. In other words, channel phase is extracted from the channel response. Upon estimating the channel phases, transmitted bits are mapped to a symbol and then the phase of the modulated symbol is equalized by an angle that is equal to the negative of instantaneous channel phase.

The proposed method provides a low-complexity receiver that can be used in future wireless devices, e.g., internet of things (IoT) devices.

The proposed method requires only a channel gain estimation which simplified the channel estimation process

The proposed invention leverages the geographically distributed transmission points offered by coordinated multipoint networks to hide the modulation type information as well as securing the transmitted data, which makes illegitimate decoding very difficult.

### EXPLANATION OF FIGURES

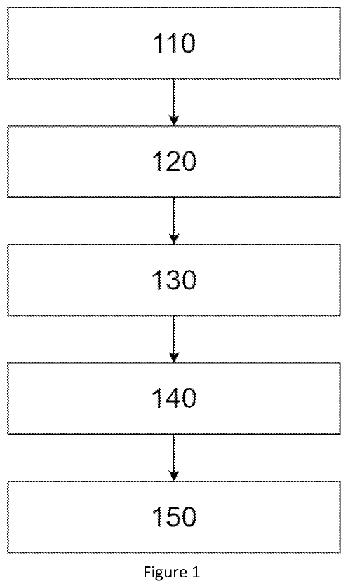

FIG. 1: Flow chart of basic operations in accordance with certain aspects of the present disclosure.
110: Estimating the wireless channel: transmitter starts a channel (gain and phase) estimation process and receiver starts a channel gain estimation process
120: Obtaining the channel phase vector from the channel estimation process at transmitter
130: Mapping the transmitted bits to the modulated symbols based on a digital modulation scheme at transmitter
140: Performing symbol phase pre-equalizing at transmitter characterized in rotating the modulated symbols by an angle that is equal to the negative of instantaneous channel phase
150: Decoding the received symbols at receiver

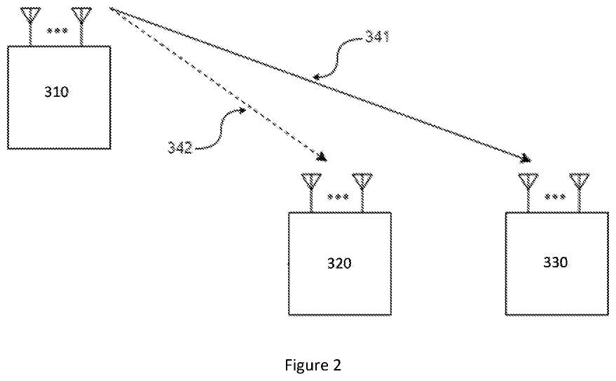

FIG. 2: Example of simple network, comprising single transmission point (TP), device and attacker with symbol phase pre-equalization in accordance with certain aspects of the present invention.
310: Transmission point (TP)
330: Device (D)
320: Attacker (A)
341: The Wireless channel between TP and Device which is used by TP (311) to pre-equalize its modulated symbols
342: The Wireless channel between TP and Attacker

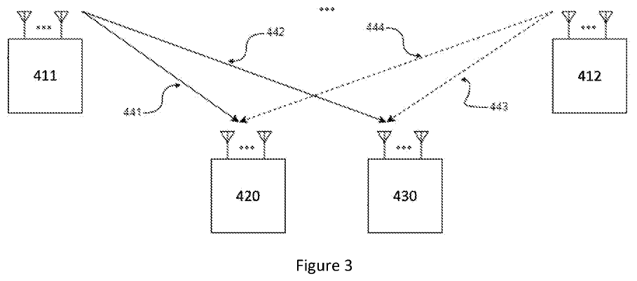

FIG. 3: Example of coordinated network with symbol phase rotation in accordance with certain aspects of the present invention.
411: First coordinated transmission point (TP-1)
412: N-th coordinated transmission point (TP-N)
441: The Wireless channel between TP-1 and Attacker
442: The Wireless channel between TP-1 and Device which is used by TP-1 (411) to pre-equalize its modulated symbols
443: The Wireless channel between TP-N and Device which is used by TP-N (412) to pre-equalize its modulated symbols
444: The Wireless channel between TP-N and Attacker
420: Attacker (A)
430: Device (D)

### DETAILED DESCRIPTION OF THE INVENTION

As mentioned above, the present invention is related to a method for improving the confidentiality against eavesdropping in wireless communications, wherein said method comprises the steps of
Estimating the wireless channel wherein said process consists of (a) transmitter starting a channel (gain and phase) estimation process and (b) receiver starting a channel gain estimation process
Obtaining the channel phase vector from the channel estimation process at transmitter
Mapping the transmitted bits to the modulated symbols based on a digital modulation scheme at transmitter
Performing symbol phase pre-equalizing at transmitter characterized in rotating the modulated symbols by an angle that is equal to the negative of instantaneous channel phase
Decoding the received symbols at receiver

In FIG. 1, a flow diagram of basic operations for wireless communication in accordance with certain aspects of the present invention is given.

Step (110) presents the operation of channel estimation process. The transmission point (310, 411, 412) and device (330, 430) whose communication is to be secured estimate the wireless channel where the transmission point (310, 411, 412) estimates both gain and phase of the wireless channel where the device (330, 430) estimates only the gain of the wireless channel since the modulated symbols will arrive at device (330, 430) scaled by only the channel gain.

Step (120) presents the phase extraction of phase vector stage. The transmission point (310, 411, 412) obtains the channel phase vector from the channel estimation process (110)

Step (130) presents mapping process. The transmission point (310, 411, 412) maps the transmitted bits of device (330, 420) to modulated symbols following a digital modulation scheme.

Step (140) presents a symbol phase pre-equalizing process. The transmission point (310, 411, 412) rotates the modulated symbols by an angle that is equal to the negative of the instantaneous channel phase. The modulated symbols are rotated independent of each other since the wireless channel (341,442, 443) does not have a flat response.

Step (150) presents a symbol decoding process. The device (330, 420) decodes the received symbols after removing the channel gain effect.

Therefore, an embodiment of the invention is a method for improving the confidentiality against eavesdropping in wireless communications, wherein estimation the wireless channel between legitimate entities (transmission point (310, 411, 412) and device (330, 420)) where the device (330, 430) estimates only the gain of the wireless channel since the modulated symbols will arrive at device (330, 430) scaled by only the channel gain.

Another embodiment of the invention is a method for improving the confidentiality against eavesdropping in wireless communications, wherein channel phase extraction process at the transmission point (310, 411, 412) comprises extracting the channel phase vector from the wireless channel (341, 442, 443) between the transmission point (310, 411, 412) and device (330, 430). No need to share anything between legitimate entities due to channel reciprocity property.

Another embodiment of the invention is a method for improving the confidentiality against eavesdropping in wireless communications, wherein mapping the transmitted bits to modulated symbols is done at the transmission point (310, 411, 412) following a digital modulation. Within this document “digital modulation” means that all the symbols will follow the same modulation rules with the specific scheme.

Another embodiment of the invention is a method for improving the confidentiality against eavesdropping in wireless communications, wherein symbol phase pre-equalization is performed by rotating modulated symbols with an angle that is equal to the negative of the instantaneous channel phase. The modulated symbols are rotated independent of each other since the wireless channel (341,442, 443) does not have a flat response.

Another embodiment of the invention is a method for improving the confidentiality against eavesdropping in wireless communications, wherein the received symbols are decoded at the device (330, 430) after removing the channel gain effect.

The embodiments of the invention pertaining to different steps of the method according to the invention can be combined in any way, meaning that all embodiments described in this description can be combined or some of the embodiments described herein can be combined.

FIG. 2 is an example of simple network which consists of three types of devices: a legitimate TP (310), legitimate device (330) and an attacker (320)

The TP (310) performs a secure communication with device (330) against attacker (320). The communication nodes can be equipped with single/multiple antennas.

The attacker (320) tries to passively sniff the wireless channel (341). Thus, the attacker (320) location and channel information (342) are unavailable to both TP (310) and device (330).

The reciprocity property of the wireless channel is assumed. To secure the transmitted data to device (330), the channel phase vector is extracted based on the wireless channel (341).

The TP (310) rotates the modulated symbols by an angle equals to the negative of instantaneous phase of the wireless channel (341).

The transmitted symbols will arrive device (330) scaled by channel (341) gain. After removing the channel gain effect, the transmitted symbols are correctly decoded.

At attacker (320), the received symbols have incorrect phase and gain so attacker (320) cannot decode them correctly

As a result, the received symbol at device (330) can be decoded correctly. But this is NOT the case at attacker (320), where the received symbol suffers from high decoding errors, which deteriorates the performance.

FIG. 3 is an example of coordinated network with symbol phase pre-equalization in accordance with certain aspects of the present disclosure

The TPs from TP-1 (411) until TP-N (412) are coordinated to secure the communication with device (430) against attacker (420). The communication nodes can be equipped with single/multiple antennas.

The N-coordinating TPs apply a symbol phase pre-equalization process (130) based on the phased vector extracted from the wireless channels between them and device (430) as TP-1 (411) use channel phase vector extracted from wireless channel (442) and TP-N (412) use channel phase vector extracted from wireless channel (444) and so on.

At device (430), The transmitted symbols will arrive device (330) scaled by channel (341) gain. After removing the channel gain effect, the transmitted symbols are correctly decoded. Channel gain equalization is based on the effective gain which is combination of the gain of the wireless channel (442) and gain of the wireless channel (444).

At attacker (420), the received symbols have incorrect phase and gain so attacker (320) cannot decode them correctly.

As a result, the combined received symbols at device (430) can be decoded correctly. But this is not the case at attacker (420), where the combined received symbols suffer from high decoding errors, which deteriorates the performance.

The coordination network helps to perform obfuscation in modulated symbols which is not only secure the transmitted information but also help to hide the modulation information.

An embodiment of the invention is use of a method according to present invention to prevent eavesdropping in a simple network which consists of a legitimate TP (310), legitimate device (330) and an attacker (320).

An embodiment of the invention is use of a method according to present invention to prevent eavesdropping in a coordinated network.

An embodiment of the invention is use of a method according to present invention on any device, system or network capable of supporting any of the aforementioned standards, code division multiple access (CDMA), frequency division multiple access (FDMA), Global System for Mobile communications (GSM), GSM/General Packet Radio Service (GPRS), Enhanced Data GSM Environment (EDGE), Wideband-CDMA (W-CDMA), Evolution Data Optimized (EV-DO), High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, 5G New Radio (NR), or other known signals that are used to communicate within a wireless, cellular or internet of things (IoT) network

In this document the term “Mapping” refers to a process of encoding a digital information signal (bit stream) into the amplitude, phase, or frequency of the transmitted signal (modulated symbols).

In this document the term “Symbol phase pre-equalization” refers to a process where the phase of the modulated symbol is rotated by an angle that is equal to the negative of instantaneous channel phase.

Around these basic concepts, it is possible to develop several embodiments regarding the subject matter of the invention; therefore the invention cannot be limited to the examples disclosed herein, and the invention is essentially as defined in the claims.

It is obvious that a person skilled in the art can convey the novelty of the invention using similar embodiments and/or that such embodiments can be applied to other fields similar to those used in the related art. Therefore it is also obvious that these kinds of embodiments are void of the novelty criteria and the criteria of exceeding the known state of the art.

### INDUSTRIAL APPLICATION OF THE INVENTION

Wireless communication is becoming an increasingly important part of human lives, with its applications ranging from banking to healthcare, education to trading, industry to agriculture, and so on. One of the most important challenges in this regard is to ensure the protection of the data exchange from being intercepted a malicious node. For this purpose, simple, lightweight and robust mechanisms are needed, particularly for low-end devices such as Internet of Thing (IoT) nodes which are heavily deployed in use cases such as precision agriculture, autonomous driving, smart homes etc. Present invention provides a simple method to improve the confidentiality against eavesdropping in wireless communication. Said method comprises of pre-equalizing the channel phase between the legitimate transceivers. This method fulfills the security requirements of communication without adding any additional processing burden, rendering it feasible for low-end devices.

1. A method for improving the confidentiality against eavesdropping in wireless communications, the method comprising:
estimating a wireless channel wherein the process comprises (a) transmitter starting a channel (gain and phase) estimation process and (b) receiver starting a channel gain estimation process;
obtaining a channel phase vector from the channel estimation process at transmitter mapping the transmitted bits to the modulated symbols based on a digital modulation scheme at transmitter;
performing symbol phase pre-equalizing at transmitter characterized in rotating the modulated symbols by an angle that is equal to the negative of instantaneous channel phase; and
decoding the received symbols at receiver.

2. The method of claim 1, wherein, channel estimation process is performed, and transmission point and device whose communication is to be secured estimate the wireless channel.

3. The method of claim 2, wherein the transmission point estimates both gain and phase of the wireless channel where the device estimates only the gain of the wireless channel.

4. The method of claim 3, wherein the modulated symbols will arrive at device scaled by only the channel gain.

5. The method of claim 1, wherein the channel phase extraction process comprises extracting the channel phase vector from the wireless channel between the transmission point and device with no need to share anything between legitimate entities due to channel reciprocity property.

6. The method of claim 1, wherein mapping the transmitted bits to modulated symbols is done following a digital modulation scheme.

7. The method of claim 1, wherein symbol phase pre-equalization is performed by rotating the modulated symbols by an angle that is equal to the negative of the instantaneous channel phase.

8. The method of claim 6, wherein the modulated symbols are rotated independent of each other based on the extracted channel phase vector.

9. The method of claim 6, wherein the symbol phase pre-equalization is based on the probed channel phases.

10. The method of claim 7, wherein the channel phases are kept secret between the legitimate entities by a channel reciprocity process.

11. The method of claim 8, wherein the channel reciprocity process comprises estimating the wireless channel by both communicating ends without a feedback link.

12. The method of claim 1, claims 1-10 wherein the received symbols required only gain equalization at legitimate device.

13. The method of claim 1, for a simple network comprising: (a) a legitimate TP, (b) legitimate device/receiver and (c) an attacker, wherein said method comprises the steps of:
legitimate TP performing a secure communication with device against attacker, wherein the communication nodes are equipped with single and/or multiple antennas;
the attacker trying to passively sniff the wireless channel;
assuming the reciprocity property of the wireless channel, to secure the transmitted data to device, the channel phase vector is extracted based on the wireless channel;
the TP rotating the transmitted symbol by an angle that is equal to the negative of instantaneous phase of the wireless channel so that at the device, the received symbol has corrected phase but only need gain equalization and at the attacker the received symbol has both incorrect phase and gain.

14. The method of claim 1 for a coordinated network with symbol phase pre-equalization; wherein said method comprises the steps of:
coordinating TPs from TP-1 until TP-N to secure the communication with device against attacker, wherein herein the communication nodes are equipped with single and/or multiple antennas;
applying a symbol phase rotation process by the N-coordinating TPs based on the phased vector extracted from the wireless channels between them and device as TP-1 use channel phase vector extracted from wireless channel and TP-N use channel phase vector extracted from wireless channel, so that at device, the received symbol has corrected phase but only need gain equalization and at attacker the received symbol has incorrect phase and gain.

15. The method of claim 13, wherein gain equalization is based on the effective gain which is combination of the gain of the wireless channel and gain of the wireless channel.

16. Use of the method according to claim 1 in systems and/or devices and/or networks capable of supporting 3GPP-based cellular and IEEE 802.11 based Wi-Fi networks, code division multiple access (CDMA), frequency division multiple access (FDMA), Global System for Mobile communications (GSM), GSM/General Packet Radio Service (GPRS), Enhanced Data GSM Environment (EDGE), Wideband-CDMA (W-CDMA), Evolution Data Optimized (EV-DO), High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, 5G New Radio (NR), or other known signals that are used to communicate within a wireless, cellular or internet of things network for improving the confidentiality against eavesdropping.

17. Use of a method according to claim 1 to prevent eavesdropping in a simple network which comprises a legitimate TP, legitimate device/receiver and an attacker.

18. Use of a method according to claim 1 to prevent eavesdropping in a coordinated network.
